(19) United States
(12) Patent Application Publication
(10) Pub. No.: US 2003/0025956 A1
(43) Pub. Date: Feb. 6, 2003

(54) Protected DWDM ring networks using wavelength selected switches

(75) Inventors: Ming Jun Li, Horseheads, NY (US); June-Koo Rhee, Morganville, NJ (US)

Correspondence Address: WALL MARJAMA & BILINSKI, 101 SOUTH SALINA STREET, SUITE 400, SYRACUSE, NY, 13202, US

(73) Assignee: Corning, Inc.

(21) Appl. No.: 10/102,079

(22) Filed: Mar. 20, 2002

Related U.S. Application Data
(60) Provisional application No. 60/277,298, filed on Mar. 20, 2001.

(51) Int. Cl. H04B 10/08; H04B 10/20; H04J 14/00

(52) U.S. Cl. 359/110; 359/119

(57) ABSTRACT

The present invention is directed to a protection switch disposed at a node in a two-fiber optical channel protection ring. The protection switch includes a wavelength selective switch (WSS) coupled to the two-fiber optical channel protection ring. The WSS is configured to selectively drop at least one wavelength channel propagating in the two-fiber optical channel protection ring. A dynamic spectral equalizer (DSE) is coupled to the two-fiber optical channel protection ring. The DSE is configured to substantially block wavelengths corresponding to the at least one wavelength channel, and to optically manage at least one express wavelength channel not corresponding to the at least one wavelength channel.

### CROSS-REFERENCE TO RELATED APPLICATIONS

This application claims priority to U.S. Provisional Patent Application 60/277,298 filed on Mar. 20, 2001, the content of which is relied upon and incorporated herein by reference in its entirety, and the benefit of priority under 35 U.S.C. §119(e) is hereby claimed.

### BACKGROUND OF THE INVENTION

1. Field of the Invention

The present invention relates generally to optical switching, and particularly to protection switching in a two-fiber ring interconnection architecture.

2. Technical Background

In the last several decades, fiber optic communication systems have transformed the telecommunications marketplace. Initially, optical network designs were simple point-to-point links. However, with switching functionality migrating from the electrical layer to the optical layer, optical network architectures have become increasingly complex. These architectures include both optical protection rings, and interconnected optical protection rings. Optical protection ring topologies are currently being deployed by network providers because of their cost savings, survivability, and ability to self-heal. Ring topologies typically include a plurality of client access nodes that are interconnected by at least two optical fibers to form a ring. The two-fiber protection ring allows traffic to be transmitted bi-directionally from node to node around the ring. Each node employs a protection switching interface that functions as a ring ingress/egress point; allowing users coupled to the node to transmit and receive messages propagating around the ring. The protection switch also may be configured to condition the optical signals passing through the node. Most importantly, protection switches allow the protection ring to survive and self-heal from fault conditions.

Optical protection rings can survive and self-heal from ring fault conditions by providing duplicate and geographically diverse paths for all of the client traffic propagating on the ring. In a two-fiber ring, this is accomplished by providing two fibers that carry traffic in opposite directions. The protection ring reserves approximately half of its bandwidth for protection purposes. Thus, if traffic is interrupted by fault condition, the ring will detect the fault condition, and route traffic around the damaged network component using the protection bandwidth until a repair can be effected.

What is needed is a simple, low cost, easy to implement channel-by-channel protection switching scheme in a DWDM ring network. What is also needed is a protection switch that includes optical add/drop multiplexing (OADM) capabilities.

### SUMMARY OF THE INVENTION

The present invention is directed to a simple, low cost, easy to implement channel-by-channel protection switching scheme for use in a DWDM ring network suitable for metro-area network applications. The present invention also provides a protection switch that includes optical add/drop multiplexing (OADM) capabilities.

One aspect of the present invention is a protection switch disposed at a node in a two-fiber optical channel protection ring. The protection switch includes a wavelength selective switch (WSS) coupled to the two-fiber optical channel protection ring. The WSS is configured to selectively drop at least one wavelength channel propagating in the two-fiber optical channel protection ring. A dynamic spectral equalizer (DSE) is coupled to the two-fiber optical channel protection ring. The DSE is configured to substantially block wavelengths corresponding to the at least one wavelength channel, and to optically manage at least one express wavelength channel not corresponding to the at least one wavelength channel.

In another aspect, the present invention includes a method for protection switching traffic between a plurality of nodes in a two-fiber optical channel protection ring. The two-fiber optical channel protection ring includes a working fiber and a protection fiber. Each node includes at least one client add port and at least one client drop port. The method includes selecting at least one wavelength channel. The at least one wavelength channel is directed into the client drop port. Wavelengths corresponding to the at least one wavelength channel are substantially blocked at the output of the at least one client add port. At least one express wavelength channel not corresponding to the at least one wavelength channel is optically managed.

In another aspect, the present invention includes a protection switch disposed at a node in a two-fiber optical channel protection ring. The node includes a client add port and a client drop port. The two-fiber optical channel protection ring includes a working fiber propagating a plurality of working wavelength channels and a protection fiber propagating a plurality of protection wavelength channels. The protection switch includes a working fiber wavelength selective switch (WSS) coupled to the working fiber. The working WSS is configured to select at least one working wavelength channel from the plurality of working wavelength channels. A protection fiber WSS is coupled to the protection fiber. The protection WSS is configured to select at least one protection wavelength channel from the plurality of protection wavelength channels. A drop port WSS is coupled to the working WSS and the protection fiber WSS. The drop port WSS is configured to selectively direct the at least one working wavelength channel and the at least one protection channel into the client drop port, whereby a selected wavelength channel not being directed into the client drop port is terminated.

In another aspect, the present invention includes a protection switch disposed at a node interconnecting a first two-fiber optical channel protection ring and a second two-fiber optical channel protection ring. The first two-fiber optical channel protection ring includes a first working fiber and a first protection fiber. The second two-fiber optical channel protection ring includes a second working fiber and a second protection fiber. The switch includes a first protection ring add port, a first protection ring drop port, a second protection ring add port, and a second protection ring drop port. The protection switch includes a first protection ring wavelength selective switch (WSS) coupled to the first working fiber and the first protection fiber. The first protection ring WSS is configured to selectively direct at least one first protection ring wavelength channel into the first protection ring drop port, and to selectively direct at least one other first protection ring wavelength channel into the second two-fiber optical channel protection ring. A second protection ring WSS is coupled to the second working fiber and the second protection fiber. The second protection ring WSS is configured to selectively direct at least one second protection ring wavelength channel into the second protection ring drop port, and to selectively direct at least one other second protection ring wavelength channel into the first two-fiber optical channel protection ring. A first dynamic spectral equalizer (DSE) is coupled to the first protection ring WSS. The first DSE is configured to optically manage the at least one other first protection ring wavelength channel being directed into the second two-fiber optical channel protection ring, and substantially block remaining first protection ring wavelength channels not being directed into the second two-fiber optical channel protection ring.

In another aspect, the present invention includes a protection switch disposed at a node interconnecting a first two-fiber optical channel protection ring and a second two-fiber optical channel protection ring. The first two-fiber optical channel protection ring includes a first working fiber and a first protection fiber. The second two-fiber optical channel protection ring includes a second working fiber and a second protection fiber. The switch includes a first protection ring add port, a first protection ring drop port, a second protection ring add port, and a second protection ring drop port. The protection switch includes a first protection ring wavelength selective switch (WSS) coupled to the first working fiber and the first protection fiber. The first protection ring WSS is configured to selectively direct any wavelength channel into the first protection ring drop port. The first protection ring WSS is also configured to selectively direct a first protection ring wavelength channel into the second two-fiber optical channel protection ring or the second protection ring drop port. A second protection ring WSS is coupled to the second working fiber and the second protection fiber. The second protection ring WSS is configured to selectively direct any wavelength channel into the second protection ring drop port. The second protection ring WSS is also configured to selectively direct a second protection ring wavelength channel into the first two-fiber optical channel protection ring or the first protection ring drop port. A wavelength selective cross-connect (WSCC) system is coupled to the first protection ring WSS and the second protection ring WSS. The WSCC system includes at least one WSS. The WSCC is configured to cross-connect any first protection ring wavelength channel into the second protection ring and cross-connect any second protection ring wavelength channel into the first protection ring.

In yet another aspect, the present invention includes a method for protection switching traffic between a plurality of nodes in a two-fiber optical channel protection ring. The two-fiber optical channel protection ring includes a working fiber and a protection fiber. Each node includes at least one client add port and at least one client drop port. The method includes providing a protection switch in each node of the plurality of nodes. Each protection switch includes a wavelength selective switch (WSS) configured to selectively drop at least one dropped wavelength channel propagating in the two-fiber optical channel protection ring. A dynamic spectral equalizer (DSE) is configured to substantially block wavelengths corresponding to the at least one wavelength channel, and to optically manage wavelength channels not corresponding to the at least one wavelength channel. At least one fault condition is detected in the two-fiber optical channel protection ring. The protection switch is actuated in response to the step of detecting, whereby the traffic is routed to avoid the at least one fault condition.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a two-fiber optical channel protection ring in accordance with a first embodiment of the present invention;

FIG. 2 is a detail view of a protection switch in a node of the two-fiber optical channel protection ring depicted in FIG. 1;

FIG. 3 is a functional block diagram of the wavelength-selective switch (WSS) depicted in FIG. 2;

FIG. 4 is a block diagram of the dynamic spectral equalizer (DSE) depicted in FIG. 2;

FIG. 5 shows the protection switch in node A of the two-fiber optical channel protection ring depicted in FIG. 1;

FIG. 6 shows the protection switch in node B of the two-fiber optical channel protection ring depicted in FIG. 1;

FIG. 7 shows the protection switch in node D of the two-fiber optical channel protection ring depicted in FIG. 1;

FIG. 8 shows the protection switch in node C of the two-fiber optical channel protection ring depicted in FIG. 1;

FIG. 9 shows the two-fiber optical channel protection ring depicted in FIG. 1 with a cable cut between nodes;

FIG. 10 shows the operation of the protection switch in node A in response to the cable cut;

FIG. 11 shows the operation of the protection switch in node B in response to the cable cut;

FIG. 12 is a detail view of the protection switch in accordance with a second embodiment of the invention;

FIG. 13 shows the protection switch depicted in FIG. 12 in a component failure mode;

FIG. 14 is a detail view of a protection switch in a node of the two-fiber optical channel protection ring in accordance with a third embodiment of the invention;

FIG. 15 is a detail view of the protection switch in accordance with a fourth embodiment of the invention;

FIG. 16 shows a network including two interconnected two-fiber optical channel protection rings in accordance with a fifth embodiment of the present invention;

FIG. 17 is a detail view of an interconnection switch employed in the interconnecting node of the network depicted in FIG. 16;

FIG. 18 is a detail view of an alternate embodiment of the interconnection switch;

FIG. 19 is a detail view of another embodiment of the interconnection switch; and

FIG. 20 is a detail view of yet another embodiment of the interconnection switch.

### DETAILED DESCRIPTION

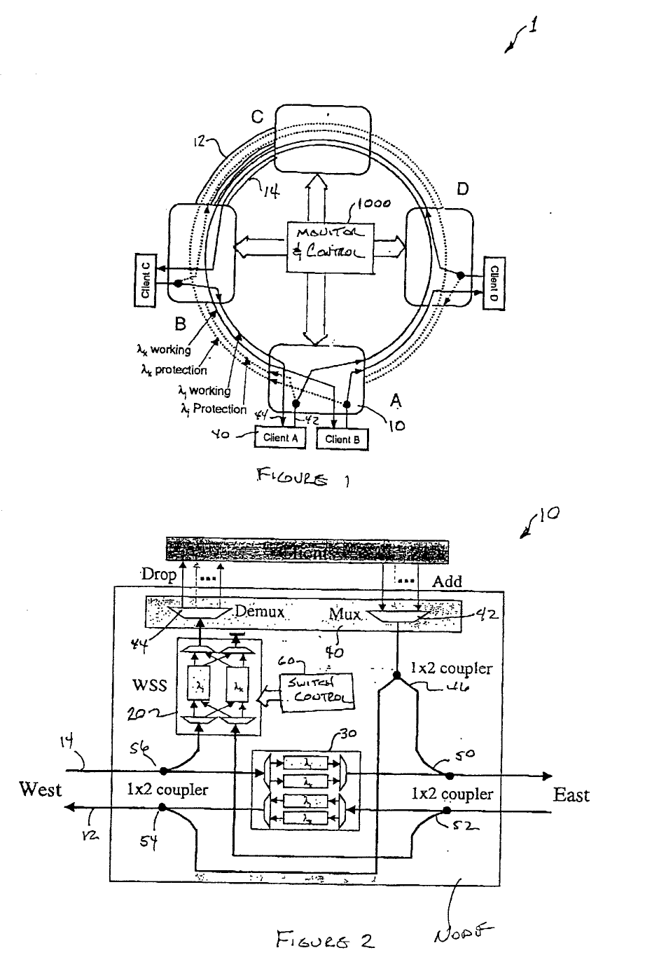

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the protection switch of the present invention is shown in FIG. 1, and is designated generally throughout by reference numeral 10.

In accordance with the invention, the present invention is directed to a protection switch disposed at a node in a two-fiber optical channel protection ring. The protection switch includes a wavelength selective switch (WSS) coupled to the two-fiber optical channel protection ring. The WSS is configured to selectively drop at least one wavelength channel propagating in the two-fiber optical channel protection ring. A dynamic spectral equalizer (DSE) is coupled to the two-fiber optical channel protection ring. The DSE is configured to substantially block wavelengths corresponding to the at least one wavelength channel, and to optically manage at least one express wavelength channel not corresponding to the at least one wavelength channel. The present invention provides a simple, low cost, easy to implement channel-by-channel protection switching scheme for use in a DWDM ring network. The present invention also provides a protection switch that includes optical add/drop multiplexing (OADM) capabilities.

As embodied herein, and depicted in FIG. 1, a two-fiber optical channel protection ring 1 in accordance with one embodiment of the present invention is disclosed. Two-fiber optical channel protection ring 1 includes working fiber 14 and protection fiber 12. Working fiber 14 propagates a plurality of working wavelength channels, and protection fiber 12 propagates a plurality of protection wavelength channels. In one embodiment, protection ring 1 supports 24 wavelength channels. In another embodiment, protection ring 1 may support up to 80 wavelength channels. As shown, protection ring 1 includes node A, node B, node C, and node D. A protection switch 10 is disposed at each node in protection ring 1. Each node may include client interface 40, which may support client add ports 42 and client drop ports 44.

FIG. 1 shows protection ring 1 under normal operating conditions. In the discussion of protection ring 1 and protection switch 10, only two wavelength channels (λj and λk) are shown for ease and clarity of illustration. As discussed above, up to 80 wavelength channels may be supported in DWDM protection ring network 1. The four nodes shown in FIG. 1 show four types of nodal configurations. Node A has two clients (client A and client B) coupled to protection ring 1. Client A uses working wavelength λj and protection wavelength λj. Client B uses working wavelength λk and protection wavelength λk. Node B has one client C, which is coupled to working wavelength λj and protection wavelength λj. With respect to wavelength λj and wavelength λk, node C is configured as a pass through node(those of ordinary skill in the art will recognize that Node C may support other wavelengths). Finally, client D (node D) is connected to working wavelength λk and protection wavelength λk.

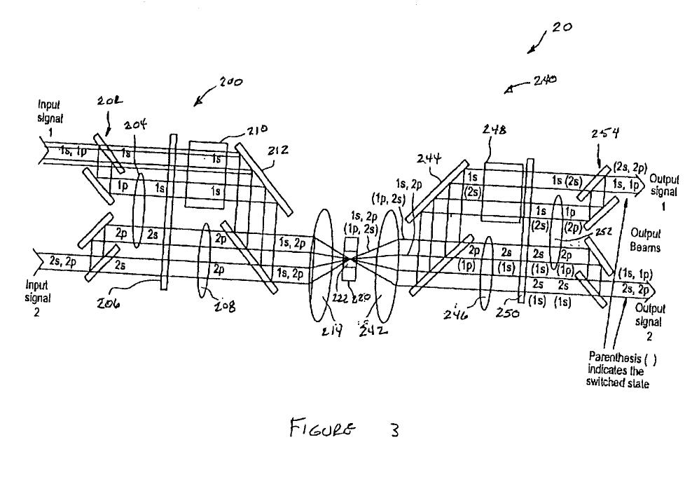

As embodied herein and depicted in FIG. 2, a detail view of protection switch 10 is disclosed. Protection switch 10 includes wavelength selective switch (WSS) 20 coupled to protection fiber 12 and working fiber 14. WSS 20 is coupled to protection fiber 12 by way of 1×2 coupler 52. WSS 20 is coupled to working fiber 14, by way of 1×2 coupler 56. The second output of coupler 52 is connected to an input of dynamic spectral equalizer 30. The second output of coupler 56 is connected to a second input of dynamic spectral equalizer 30. Coupler 52 splits the optical signal propagating on protection fiber 12 into two copies. One copy is directed into DSE 30, whereas the second copy is directed into WSS 20. Coupler 56 performs a similar function. Coupler 56 provides one copy of the optical signal propagating on working fiber 14 to DSE 30, and another copy to WSS 20. One output of WSS 20 is connected to drop port 44 of client interface 40. The second output of WSS 20 is terminated.

Client interface 40 also includes add port 42. When a wavelength channel is dropped to a client, the channel is replaced by a client add channel in the same spectral band as the dropped channel. One function of add port 42 is to optically multiplex the add channels together. Add port 42 is connected to 1×2 coupler 46. Coupler 46 splits the multiplexed add signal into two copies. One copy is directed into protection fiber 12 by way of coupler 54, and the other copy is directed into working fiber 14, by way of coupler 50.

Protection switch 10 also includes a control module 60 which is coupled to ring controller 1000. Control module 60 actuates WSS 20 and DSE 30 based on the protection ring traffic plan and any detected fault conditions.

In FIG. 2, WSS 20 is represented functionally in the context of FIG. 1. Although WSS 20 is shown as only accommodating two wavelength channels (λj and λk), those of ordinary skill in the art will recognize that WSS 20 may accommodate all of the wavelength channels in DWDM protection ring 1. WSS 20 is represented functionally as a pair of 2×2 switching elements. Each switching element is coupled to an input multiplexer and an output multiplexer. The input multiplexer provides each switching element with a working channel and protection channel of the same wavelength. Each switching element decides whether the working channel will be dropped or if the protection wavelength will be dropped. The wavelength channel not dropped by WSS 20 is terminated. A more detailed discussion of WSS 20 is provided in the disclosure associated with FIG. 3.

DSE 30 is also represented functionally in FIG. 2. DSE 30 is shown as managing the power levels of wavelength channels λj and λk. As discussed above, any or all of the wavelength channels in DWDM protection ring 1 may be managed by DSE 30, depending on the traffic plan. DSE 30 is represented as a pair of optical attenuators. One attenuator is coupled to protection fiber 12 and the other attenuator is coupled to working fiber 14. Each attenuator includes a demultiplexer which splits the DWDM optical signal into its constituent wavelength channels. Each attenuator element accommodates one wavelength channel. Thus, each channel in the DWDM system can be individually managed. After power management, the regulated channels are re-multiplexed. One output of DSE 30 is coupled to protection fiber 12. The other is directed into working fiber 14. If a wavelength channel is being dropped by WSS 20, the corresponding attenuating element in DSE 30 is driven to an open state to prevent the dropped channel from interfering with the add channel replacing it.

Those of ordinary skill in the art will recognize that WSS 20 may be of any suitable type, depending on cost and switch fabric selection, but there is shown by way of example in FIG. 3, a polarization modulating wavelength selective switch (WSS). FIG. 3 is a functional block diagram of WSS 20 from a polarization management perspective. Referring to FIG. 3, input signal S1 and input signal S2 correspond to working fiber 14 and protection fiber 12, respectively. Polarizing beam splitter 202 creates beamlets 1s and 1p from input signal S1, and beamlets 2s and 2p from input signal S2. The p-polarized components of S1 and S2 pass through half-wave plate 204, creating four beamlets (1s, 1s, 2s, 2s) having the same s-polarization state. Those of ordinary skill in the art will recognize that the polarization state could be reversed, such that all of the components are p-polarized. Subsequently, four beamlets pass through demultiplexer 206. Demultiplexer 206 separates the DWDM beamlets into their constituent wavelength channels. For ease and clarity of illustration, only one wavelength channel is depicted in FIG. 3. The s-polarized components of each wavelength channel in signal S2 pass through half-wave plate 208 to create polarization diversity. The s-polarized components from signal S1 remain s-polarized. However, the s-polarized components pass through optical compensator 210. Since the signal S1 components travel a shorter distance in the absence of compensator 210, compensator 210 is needed to equalize the optical distances traveled by both signals. The optical distance is defined as the distance traveled by the light, divided by the refractive index of the propagation medium. Beam combiner 212 creates two identical sets of superimposed signal (1s, 2p). By superimposing the s-polarized signal with the p-polarized signal, each superimposed signal includes the information payload from both signal S1 and S2. The two signal sets are directed by focusing lens 214 onto switching cell 222 of polarization modulator 220.

In one embodiment, polarization modulator 220 is a twisted nematic liquid crystal modulator. In an off-voltage state, the twisted helix configuration of liquid crystal switching cell 222 causes the polarization state of the input superimposed signal sets to rotate substantially 90° by adiabatic following. In a high voltage state, the helical arrangement formed by the liquid crystal molecules within cell 222 is disrupted, and the polarization state of the incident signal propagates through cell 222 substantially unchanged. Output birefringent optical system 240 is symmetrical to input birefringent optical system 200. Thus, when liquid crystal switching cell 222 is in the high voltage state, WSS 20 is in the bar state. When liquid crystal switching cell 222 is in the low-voltage state, WSS 20 is in the cross-state (see the output signal components in parenthesis). Those of ordinary skill in the art will recognize that other polarization modulating devices may be employed. For example, crystals having a variable birefringence dependent upon an applied voltage respond in much the same way as liquid crystal devices. Ferroelectric liquid crystal rotators, magneto-optical Faraday rotators, acousto-optic rotators, or other electro-optic rotators may be employed as well. Reference is made to U.S. Pat. No. 6,285,500, U.S. patent application Ser. No. 09/948,380, U.S. patent application Ser. No. 09/901,382, and U.S. patent application Ser. No. 09/429,135, which are incorporated herein by reference as though fully set forth in its entirety, for a more detailed explanation of WSS 20.

Those of ordinary skill in the art will recognize that polarization beam splitters 202 and 244, and polarization beam combiners 212 and 254 may be of any suitable type, depending on desired tolerances, package size, expense, and mounting requirements of protection switch 10. For example, these devices may be embodied by beam splitting cubes, birefringent plates, prisms or by thin-film filter devices.

Optical compensators 210 and 248 may be of any suitable type, but there is shown by way of example, a polished plate of glass having a precise thickness, and hence, a component characterized as having a precise optical distance. However, one of ordinary skill in the art will recognize that any optical design or material that equalizes the optical distances of the first signal and the second signal may be employed.

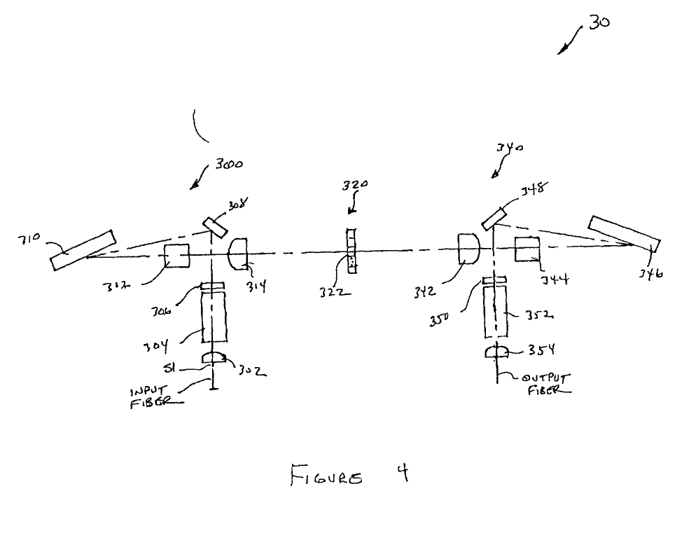

As embodied herein and depicted in FIG. 4, a block diagram of the dynamic spectral equalizer (DSE) 30 depicted in FIG. 2 is disclosed. DSE 30 may be of any suitable type, depending on cost and the design of the attenuation fabric. By way of example, DSE 30 may be implemented as a modified version of WSS 20. As such, DSE 30 includes a polarization modulator 320 disposed between an input optical system 300 and an output optical system 340. Input optical system 300 includes collimator 302 connected to the input fiber. The output of collimator 302 is coupled to polarization beam splitter 304. Beam splitter 304 is of the same type as beam splitter 202, depicted in FIG. 3. Polarizing beam splitter 304 creates beamlets 1s and 1p from the input signal. The p-polarized component of S1 passes through half-wave plate 306. As a result, two beamlets (1s, 1s) having the same s-polarization state are created. Obviously, those of ordinary skill in the art will recognize that the polarization state could be reversed, such that all of the components are p-polarized. Referring back to FIG. 4, the beamlets are reflected off fold-mirror 308 towards demultiplexer 310. Demultiplexer 310 separates the beamlets into their constituent wavelength channels. Again, only one wavelength channel is depicted in FIG. 4, for clarity of illustration. Subsequently, beamlets (1s,1s) are directed by focusing lens 314 onto attenuation cell 322 of polarization modulator 320. Although the active element in modulator 320 substantially the same as the active element in modulator 220 (FIG. 3), they are driven in much different ways. Modulator 220 accommodates two input signals and is driven between two switching states. As discussed above, a cross-state results from no ( or a minimal) voltage being applied, whereas a bar state results from a predetermined voltage being applied. In contrast, modulator 320 accommodates one signal and is continuously variable between a fully transmissive state (e.g., having minimal optical losses), and a fully attenuated state (having minimal signal leakage). As shown, modulator 320 includes polarization modulating attenuators 322 for each wavelength channel in the DWDM system.

The component descriptions for WSS 20 are equally applicable to DSE 30. Reference is also made to U.S. Pat. No. 6,285,500, U.S. patent application Ser. No. 09/948,380, U.S. patent application Ser. No. 09/901,382, and U.S. patent application Ser. No. 09/429,135, which are incorporated herein by reference as though fully set forth in its entirety, for a more detailed explanation of DSE 30.

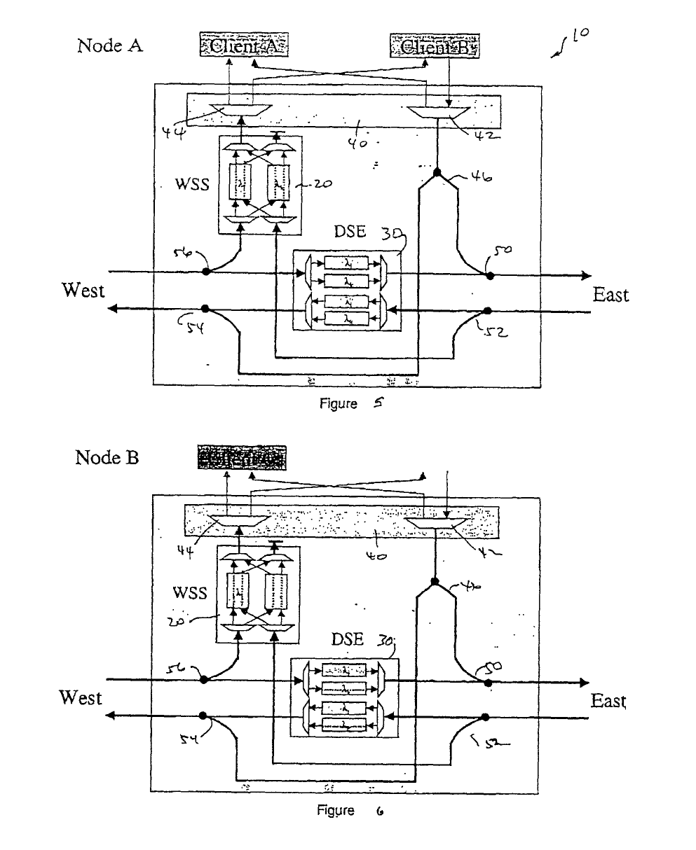

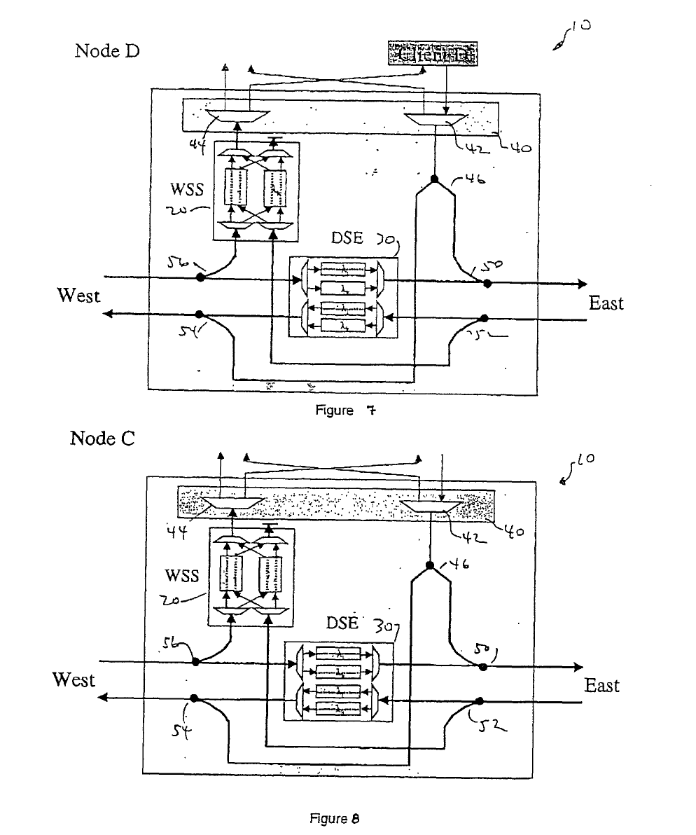

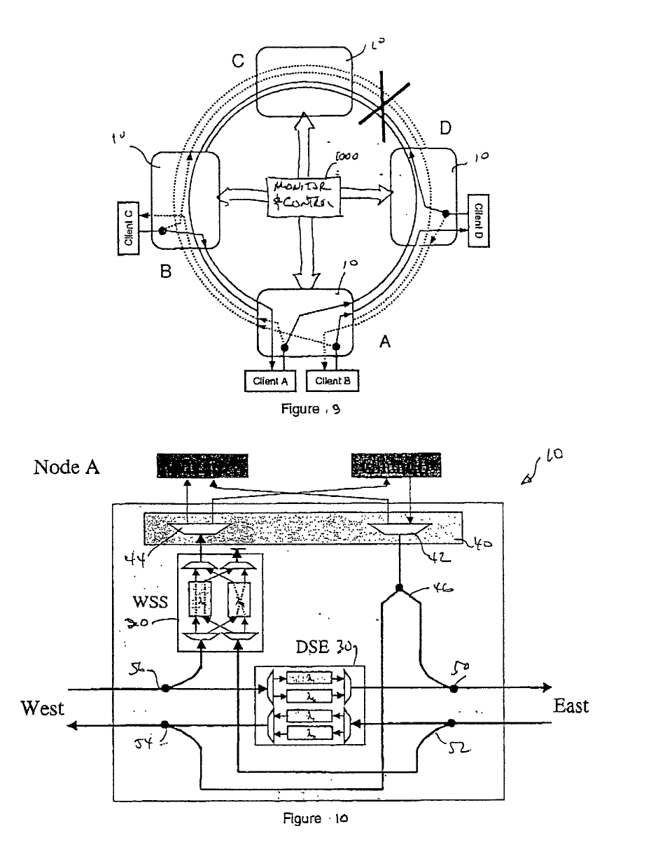

Referring back to FIG. 1, the connections in the protection switches inside the four nodes depicted in FIG. 1, are shown in FIG. 5, FIG. 6, FIG. 7, and FIG. 8. Once again, using the conventions developed in FIG. 1 and FIG. 2, only wavelength channel λj and wavelength channel λk are shown.

FIG. 5 shows the protection switch in node A operating under normal conditions. Client A traffic propagates on wavelength channel λj and client B traffic propagates on wavelength channel λk. WSS 20 is in the bar state causing working wavelength channel λj and working wavelength channel λk to be dropped. WSS 20 directs protection wavelength channel λj and protection wavelength channel λk to a termination port. Since working wavelength channel λj and working wavelength channel λk are being dropped, and since protection wavelength channel λj and protection wavelength channel λk are terminated, DSE 30 blocks these channels to prevent them from propagating through the node and interfering with newly added channels. Add port 42 directs add wavelength channel λj and add wavelength channel λk into both working fiber 14 and protection fiber 12.

FIG. 6 shows the protection switch in node B operating under normal conditions. Client C traffic propagates on wavelength channel λj. WSS 20 directs working wavelength channel λj into drop port 44, whereas protection wavelength channel λj is terminated. DSE 30 blocks both working wavelength channel λj and protection wavelength channel λj to prevent interference with the replacement add channels. DSE 30 allows all other working wavelength channels and protection wavelength channels to propagate through node B after regulating their power levels.

FIG. 7 shows the protection switch in node D operating under normal conditions. Client D traffic propagates on wavelength channel λk. WSS 20 directs working wavelength channel λk into drop port 44, whereas protection wavelength channel λk is terminated. DSE 30 blocks both working wavelength channel λk and protection wavelength channel λk to prevent interference with the replacement add channels. DSE allows all other working wavelength channels and protection wavelength channels to propagate through node D after regulating their power levels.

FIG. 8 shows the protection switch in node C operating under normal conditions. Node C is a pass-through node, not connected to either wavelength channel λj or wavelength channel λk. Thus, neither channel is dropped by WSS 20, and neither channel is added. Thus, DSE 30 allows the working and protection channels of these wavelengths to propagate through Node C after applying an appropriate amount of attenuation.

FIG. 9 shows protection ring 1 with a cable cut between node C and D. The cable cut interrupts the working traffic between client A and client C. It also interrupts the working traffic between client D and client B. In order to restore traffic, client B and client C switch to the protection copies propagating on the protection wavelengths. After client B and client C perform protection switching, there is no need for node C or node D to switch.

FIG. 10 shows the operation of the protection switch in node A in response to the cable cut. WSS 20 is actuated to drop protection wavelength channel λk and terminate working wavelength channel λk. This allows client B to receive working traffic from client D via protection wavelength channel λk. Client A continues to receive working wavelength channel λj from client C. However, the cable cut does not allow client C to receive working wavelength channel λj from client A. Referring to FIG. 11, the WSS 20 in Node B is actuated to drop protection wavelength channel λj and terminate working wavelength channel λj. This allows client C to receive working traffic from client A via protection wavelength channel λj.

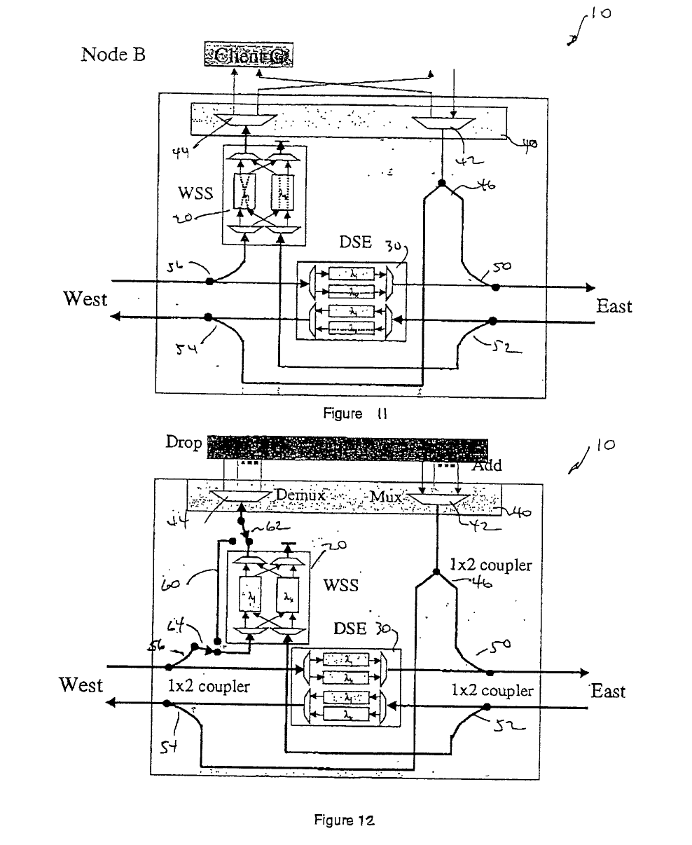

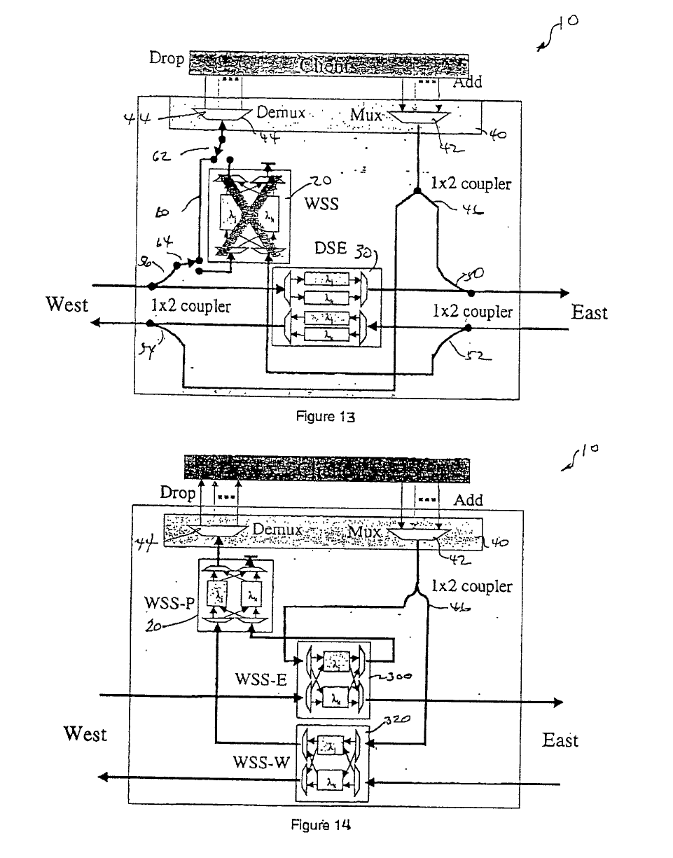

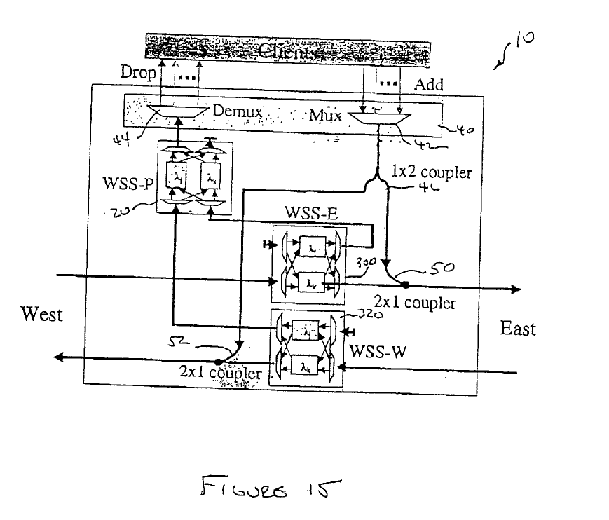

FIG. 12 is a detail view of protection switch 10 in accordance with a second embodiment of the invention. By-pass mechanism 60 is added to mitigate the effects of a WSS 20 component failure. By-pass mechanism 60 includes fiber switch 62 coupled between the drop output of WSS 20, and the input of client drop interface 44. A second fiber switch 64 is coupled between an output of coupler 56 and an input of WSS 20. Referring to FIG. 13, by-pass mechanism 60 allows traffic to by-pass WSS 20 in the event of a component failure. Those of ordinary skill in the art will recognize that by-pass mechanism 60 could also be used to by-pass DSE 30 in the event of component failure. In by-pass mode, channel-by-channel protection is not available. In terms of other component failures, those of ordinary skill in the art will recognize that multiplexers, demultiplexers, and couplers are passive devices that have failure rates that are much lower than those of active devices.

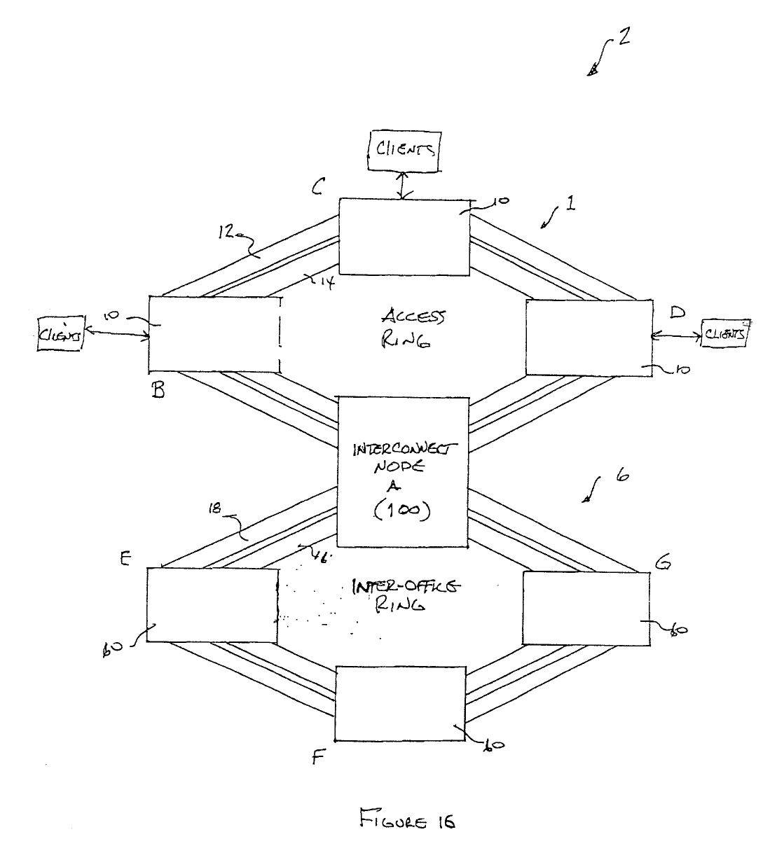

FIG. 14 is a detail view of a protection switch in a node of the two-fiber optical channel protection ring in accordance with a third embodiment of the invention. In this embodiment, DSE 30 and coupler 50, coupler 52, coupler 54, and coupler 56, are replaced by working fiber WSS 300 and protection fiber WSS 320. This embodiment has all of the functionality provided by the embodiment depicted in FIG. 2, including add/drop and individual wavelength channel power management capabilities. For channels that are dropped and added, WSS 300 and WSS 320 are driven into the cross-state. For express channels passing through the node, WSS 300 and WSS 320 are driven to individually attenuate each express channel in accordance with predetermined power management levels.

The protection switch 10 of FIG. 15 is very similar to the protection switch depicted in FIG. 14. In this embodiment, WSS 300 and WSS 320 are configured as 1×2 switches having a 2×1 coupler disposed on the express output of the WSS. One advantage of using this configuration is that it mitigates possible WSS cross-talk and eliminates WSS filtering that results in bandwidth narrowing.

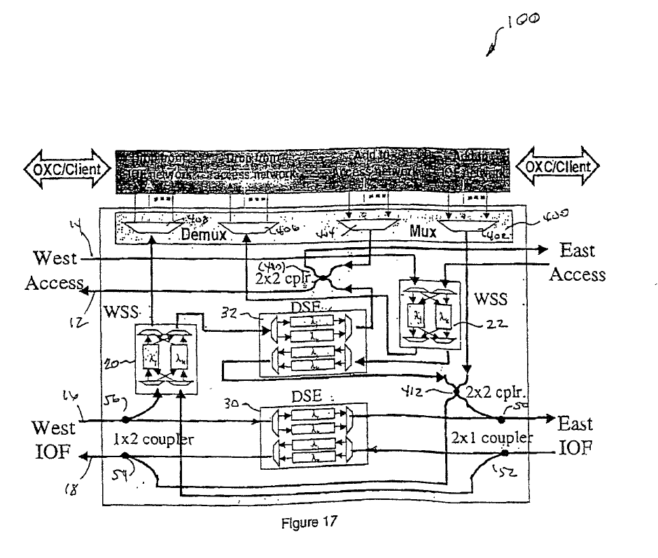

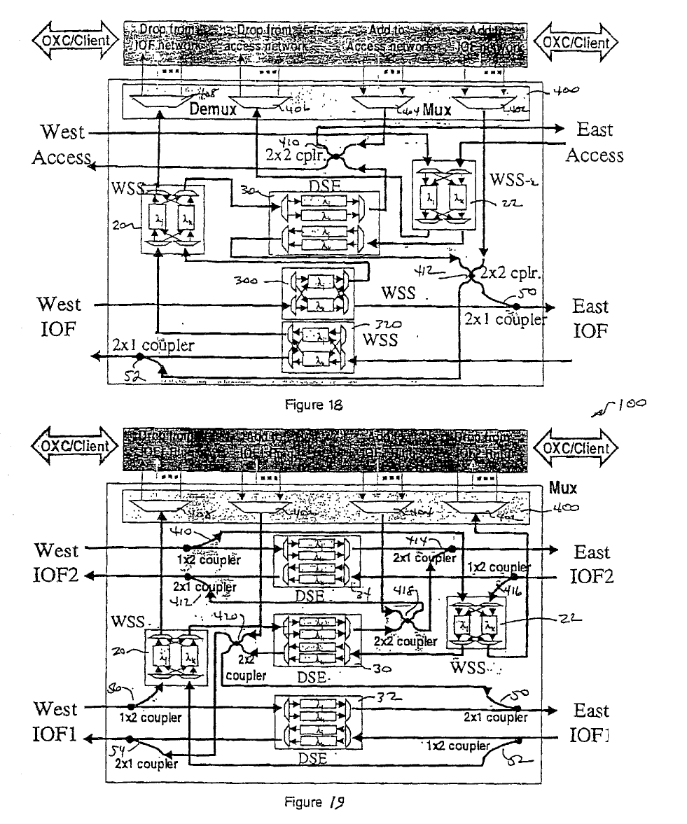

As embodied herein and depicted in FIG. 16, a network including two interconnected two-fiber optical channel protection rings is disclosed. Each node in access ring 1 includes a protection switch 10 of the type discussed above. Access ring 1 and inter-office fiber (IOF)ring 6 are interconnected using interconnection switch 100.

Referring to FIG. 17, a detail view of interconnection switch 100 is shown. Interconnection switch 100 includes four major components: WSS 20, WSS 22, DSE 30, and DSE 32. The inputs of WSS 20 are coupled to IOF working fiber 16 and IOF protection fiber 18 via 1×2 coupler 56 and 1×2 coupler 52, respectively. One output of WSS 20 is coupled to IOF drop port 408. The other output is connected to DSE 32. WSS 20 performs two functions. WSS 20 selects IOF drop channels from either IOF fiber. The IOF drop channels are directed into IOF drop port 408. WSS 20 also selects cross-connect wavelength channels from either IOF fiber. IOF cross connect wavelength channels are provided to DSE 32, and ultimately are directed into access ring 1.

The inputs of WSS 22 are directly connected to access ring working fiber 14 and access ring protection fiber 12. One output of WSS 22 is coupled to access network drop port 406. The second output is connected to the second input of DSE 32. WSS 22 has a function similar to that of WSS 20. WSS 22 selects access ring drop channels from either working fiber 14 or protection fiber 12. Access ring drop channels are directed into access ring drop port 406. WSS 22 also selects access wavelength channels for cross-connect. Access ring cross connect wavelength channels are provided to DSE 32.

As described above, the inputs of DSE are coupled to WSS 20 and WSS 22. DSE 32 has two functions. It performs power management of the cross-connected wavelength channels and it also blocks IOF express traffic.

The outputs of DSE 32 are coupled to coupler 410 and coupler 412. Coupler 410 is also connected to access ring add port 404. Thus, coupler 410 directs IOF cross-connect channels and add traffic into access ring working fiber 14 and access ring protection fiber 12. Coupler 412 is also connected to IOF add port 402. Thus, coupler 412 directs access ring channels and add traffic into IOF working fiber 16 and IOF protection fiber 18.

Both the inputs and the outputs of DSE 30 are coupled to IOF working fiber 16 and IOF protection fiber 18. DSE 30 also has two functions. The IOF wavelength channels that are dropped or cross-connected via WSS 20 are blocked. Second, the power levels of the remaining IOF wavelength channels (e.g., those that are not dropped or cross-connected) are individually managed by DSE 30.

The switch architecture depicted in FIG. 18 does not allow express access-to-access wavelength channels to propagate directly through the node. Express access-to-access wavelength channels are dropped via access ring drop port 406 and added back via access ring add port 404.

As embodied herein and depicted in FIG. 18, a modified version of the switch depicted in FIG. 17 is disclosed. In this embodiment, DSE 30 and couplers 54 and 56 in FIG. 17), are replaced by WSS 300 and WSS 320. Those of ordinary skill in the art will recognize that coupler 54 and coupler 56 are passive devices that split incident optical signal into two identical copies. Thus, the couplers provide WSS 20 with all of the wavelength channels propagating in the optical signal. By making the above described replacement, wavelength channels from working IOF fiber 16 and protection IOF fiber 18 can be selectively directed into WSS 20.

As embodied herein and depicted in FIG. 19, a detail view of another embodiment of interconnection switch 100 is disclosed. This embodiment differs from the one depicted in FIG. 17 in that an additional DSE 34 is employed. The addition of DSE 34 yields a symmetric design that provides access ring 1 with the same capabilities as IOF network 6. In FIG. 17, express access-to-access wavelength channels were dropped via access ring drop port 406 and added back via access ring add port 404. The addition of DSE 34 allows express access-to-access wavelength channels to propagate directly through the node.

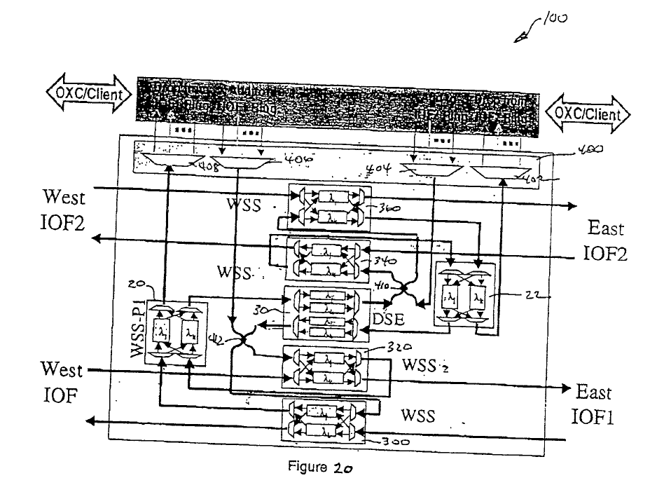

As embodied herein and depicted in FIG. 20, a detail view of yet another embodiment of interconnection switch 100 is disclosed. This embodiment modifies the switch depicted in FIG. 19 in two respects. DSE 32 is replaced with WSS 300 and WSS 320, and DSE 34 is replaced with WSS 340 and WSS 360. These replacements have the effect of providing switch 100 with the features of the architectures depicted in both FIG. 18 and FIG. 19. WSS 300 and WSS 320 are symmetrical with WSS 340 and WSS 360 about DSE 30. This arrangement allows express access-to-access wavelength channels, as well as express IOF wavelength channels, to propagate directly through the node. The reader will recall that in FIG. 17, express access-to-access wavelength channels were dropped via access ring drop port 406 and added back via access ring add port 404. Second, by replacing each DSE and its associated couplers with a WSS pair, wavelength channels from working IOF fiber 16 and protection IOF fiber 18 can be selectively directed into WSS 20, and wavelength channels from working access fiber 14 and protection access fiber 12 can be selectively directed into WSS 22. The function of WSS 20 and WSS 22 remains unchanged.

As described above, the protection switches embodied herein are a low cost devices that provide channel-by-channel cross-connectivity as well as dedicated protection switching. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A protection switch disposed at a node in a two-fiber optical channel protection ring, the protection switch comprising:
a wavelength selective switch (WSS) coupled to the two-fiber optical channel protection ring, the WSS being configured to selectively drop at least one wavelength channel propagating in the two-fiber optical channel protection ring; and
a dynamic spectral equalizer (DSE) coupled to the two-fiber optical channel protection ring, the DSE being configured to substantially block wavelengths corresponding to the at least one wavelength channel, and to optically manage at least one express wavelength channel not corresponding to the at least one wavelength channel.

2. The switch of claim 1, wherein the two-fiber optical channel protection ring includes a working fiber propagating a plurality of working wavelength channels and a protection fiber propagating a plurality of protection wavelength channels.

3. The switch of claim 2, wherein the WSS further comprises:
at least one demultiplexer component coupled to the two-fiber optical channel protection ring, the at least one demultiplexer demultiplexing a working optical signal propagating on the working fiber into the plurality of working wavelength channels, and demultiplexing a protection wavelength signal propagating on the protection fiber in to the plurality of protection wavelength channels;
a switch fabric coupled to the at least one demultiplexer, the switch fabric being configured to switch each of the plurality of working wavelength channels and each of the plurality of protection wavelength channels between a drop output and a termination output; and
at least one multiplexer component coupled to the switch fabric, the at least one multiplexer being configured to multiplex wavelength channels directed into the drop output into a DWDM drop signal.

4. The switch of claim 3, wherein the DWDM drop signal is directed into a client drop interface.

5. The switch of claim 4, wherein the client drop interface includes a demultiplexer configured to provide clients with individual drop wavelength channels.

6. The switch of claim 3, wherein the at least one multiplexer being configured to multiplex wavelength channels directed into the termination output.

7. The switch of claim 3, wherein the switch fabric includes at least one polarization modulator.

8. The switch of claim 7, wherein the at least one polarization modulator is a liquid crystal device.

9. The switch of claim 2, wherein the DSE further comprises:
at least one DSE demultiplexer component coupled to the two-fiber optical channel protection ring, the at least one demultiplexer demultiplexing a working optical signal propagating on the working fiber into the plurality of working wavelength channels, and demultiplexing a protection wavelength signal propagating on the protection fiber in to the plurality of protection wavelength channels;
a power management device coupled to the at least one DSE demultiplexer, the power management device being configured to dynamically regulate the optical power of each of the plurality of working wavelength channels and each of the plurality of protection wavelength channels; and
at least one DSE multiplexer component coupled to the power management device, the at least one DSE multiplexer component being configured to multiplex the plurality of working wavelength channels into a working fiber DWDM signal and multiplex the plurality of protection wavelength channels into a protection fiber DWDM signal.

10. The switch of claim 9, wherein the switch fabric includes at least one polarization modulator.

11. The switch of claim 10, wherein the at least one polarization modulator is a liquid crystal device.

12. The switch of claim 2, wherein the DSE further comprises:
a working fiber 1×1 optical device, the working fiber 1×1 optical device being configured to dynamically regulate the optical power of each of the plurality of working wavelength channels; and
a protection fiber 1×1 optical device, the protection fiber 1×1 optical device being configured to dynamically regulate the optical power of the plurality of protection wavelength channels.

13. The switch of claim 12, wherein the working fiber 1×1 optical device and the protection fiber 1×1 optical device each include at least one polarization modulator.

14. The switch of claim 13, wherein the at least one polarization modulator is a liquid crystal device.

15. The switch of claim 1, further comprising a client interface coupled to the WSS, the client interface being configured to provide the at least one wavelength channel to a client drop port.

16. The switch of claim 15, wherein the at least one wavelength channel includes a plurality of wavelength channels, the client interface being configured to provide each client drop port with a corresponding one of the plurality of wavelength channels.

17. The switch of claim 15, wherein the client interface is coupled between at least one client add port and the two-fiber optical channel protection ring.

18. The switch of claim 17, wherein the client interface includes an optical device configured to generate two copies of each added wavelength channel, such that one copy is directed into the working fiber and another copy is directed into the protection fiber.

19. The switch of claim 18, wherein the optical device is a coupler.

20. The switch of claim 1, further comprising a by-pass switching component coupled to the WSS, the two-fiber optical channel protection ring, and a client interface.

21. The switch of claim 20, wherein the by-pass switching component is configured to by-pass the WSS when the WSS is in a failed state.

22. A method for protection switching traffic between a plurality of nodes in a two-fiber optical channel protection ring, the two-fiber optical channel protection ring including a working fiber and a protection fiber, each node including at least one client add port and at least one client drop port, the method comprising:
selecting at least one wavelength channel; directing the at least one wavelength channel into the client drop port; and
substantially blocking wavelengths corresponding to the at least one wavelength channel at the output of the at least one client add port; and
managing at least one express wavelength channel not corresponding to the at least one wavelength channel.

23. The method of claim 22, wherein the step of selecting includes demultiplexing at least one working wavelength channel and at least one protection wavelength channel, the at least one working wavelength channel and the at least one protection wavelength channel occupying a spectral bandwidth.

24. The method of claim 23, wherein the step of selecting includes choosing between the at least one working wavelength channel and the at least one protection wavelength channel.

25. The method of claim 24, wherein an unselected one of the at least one working wavelength channel and the at least one protection wavelength channel is terminated.

26. The method of claim 22, further comprising the step of adding at least one add wavelength channel to replace the at least one channel in the two-fiber optical channel protection ring.

27. The method of claim 26, wherein the step of adding includes generating two-copies of each add wavelength channel, such that one copy is directed into the working fiber and another copy is directed into the protection fiber.

28. The method of claim 22, wherein the step of managing includes regulating the optical power of the at least one express wavelength channel not corresponding to the at least one wavelength channel.

29. The method of claim 28, wherein the at least one express wavelength channel includes a plurality of express wavelength channels.

30. The method of claim 29, wherein each of the plurality of express wavelength channels are individually regulated.

31. A protection switch disposed at a node in a two-fiber optical channel protection ring, the node including a client add port and a client drop port, the two-fiber optical channel protection ring including a working fiber propagating a plurality of working wavelength channels and a protection fiber propagating a plurality of protection wavelength channels, the protection switch comprising:
a working fiber wavelength selective switch (WSS) coupled to the working fiber, the working WSS being configured to select at least one working wavelength channel from the plurality of working wavelength channels;
a protection fiber WSS coupled to the protection fiber, the protection WSS being configured to select at least one protection wavelength channel from the plurality of protection wavelength channels;
a drop port WSS coupled to the working WSS and the protection fiber WSS, the drop port WSS being configured to selectively direct the at least one working wavelength channel and the at least one protection channel into the client drop port, whereby a selected wavelength channel not being directed into the client drop port is terminated.

32. The switch of claim 31, wherein unselected ones of the plurality of working channels are express working channels, the working fiber WSS being configured to propagate the express working channels on the working fiber.

33. The switch of claim 32, wherein the working fiber WSS is configured to optically condition the express working channels before propagating them on the first working fiber.

34. The switch of claim 33, wherein the working fiber WSS is configured to individually manage the optical power of each express working channel.

35. The switch of claim 31, wherein unselected ones of the plurality of protection channels are express protection channels, the protection fiber WSS being configured to propagate the express protection channels on the protection fiber.

36. The switch of claim 35, wherein the protection fiber WSS is configured to optically condition the express protection channels before propagating them on the first protection fiber.

37. The switch of claim 36, wherein the protection fiber WSS is configured to individually manage the optical power of each express protection channel.

38. The switch of claim 31, further comprising a client add port coupled to an input of the working fiber WSS and an input of the protection fiber WSS.

39. The switch of claim 38, wherein the client add port includes an optical device configured to generate two copies of each added wavelength channel, such that one copy is directed into the working fiber WSS and another copy is directed into the protection fiber WSS.

40. The switch of claim 31, further comprising a client add port coupled to the working fiber and the protection fiber WSS.

41. The switch of claim 40, wherein the client add port includes an optical device configured to generate two copies of each added wavelength channel, such that one copy is directed into the working fiber and another copy is directed into the protection fiber.

42. The switch of claim 31, wherein the working fiber WSS, the protection fiber WSS, and the drop port WSS each include at least one polarization modulator.

43. The switch of claim 42, wherein the at least one polarization modulator is a liquid crystal device.

44. A protection switch disposed at a node interconnecting a first two-fiber optical channel protection ring and a second two-fiber optical channel protection ring, the first two-fiber optical channel protection ring including a first working fiber and a first protection fiber, the second two-fiber optical channel protection ring including a second working fiber and a second protection fiber, the switch including a first protection ring add port, a first protection ring drop port, a second protection ring add port, and a second protection ring drop port, the protection switch comprising:
a first protection ring wavelength selective switch (WSS) coupled to the first working fiber and the first protection fiber, the first protection ring WSS being configured to selectively direct at least one first protection ring wavelength channel into the first protection ring drop port, and to selectively direct at least one other first protection ring wavelength channel into the second two-fiber optical channel protection ring;
a second protection ring WSS coupled to the second working fiber and the second protection fiber, the second protection ring WSS being configured to selectively direct at least one second protection ring wavelength channel into the second protection ring drop port, and to selectively direct at least one other second protection ring wavelength channel into the first two-fiber optical channel protection ring; and
a first dynamic spectral equalizer (DSE) coupled to the first protection ring WSS, the first DSE being configured to optically manage the at least one other first protection ring wavelength channel being directed into the second two-fiber optical channel protection ring, and substantially block remaining first protection ring wavelength channels not being directed into the second two-fiber optical channel protection ring.

45. The protection switch of claim 44, wherein the first DSE is also coupled to the second protection ring WSS, the first DSE being configured to optically manage the at least one other second protection ring wavelength channel being directed into the first two-fiber optical channel protection ring, and substantially block remaining second protection ring wavelength channels not being directed into the first two-fiber optical channel protection ring.

46. The protection switch of claim 44, further comprising a second DSE coupled to the first working fiber and the first protection fiber, the second DSE being configured to manage express first protection ring wavelength channels not being directed into the first protection ring drop port or into the second two-fiber optical channel protection ring.

47. The protection switch of claim 46, wherein the second DSE is also configured to substantially block wavelengths corresponding to first protection ring wavelength channels being directed into the first protection ring drop port or the second two-fiber optical channel protection ring.

48. The protection switch of claim 46, further comprising a third DSE coupled to the second working fiber and the second protection fiber, the third DSE being configured to manage express second protection ring wavelength channels not being directed into the second protection ring drop port or into the first two-fiber optical channel protection ring.

49. The protection switch of claim 48, wherein the third DSE is also configured to substantially block wavelengths corresponding to second protection ring wavelength channels being directed into the second protection ring drop port or into the first two-fiber optical channel protection ring.

50. The protection switch of claim 44, further comprising:
a first 1×2 WSS having an input coupled to the first working fiber, an output coupled to the first protection ring WSS, and an output coupled to the first working fiber, the first 1×2 WSS being configured to selectively direct at least one wavelength channel to the first protection ring WSS and to selectively direct at least one express wavelength channel into the first working fiber; and
a second 1×2 WSS having an input coupled to the first protection fiber, an output coupled to the first protection ring WSS, and an output coupled to the first protection fiber, the first 1×2 WSS being configured to selectively direct at least one wavelength channel to the first protection ring WSS and to selectively direct at least one express wavelength channel into the first protection fiber.

51. A protection switch disposed at a node interconnecting a first two-fiber optical channel protection ring and a second two-fiber optical channel protection ring, the first two-fiber optical channel protection ring including a first working fiber and a first protection fiber, the second two-fiber optical channel protection ring including a second working fiber and a second protection fiber, the switch including a first protection ring add port, a first protection ring drop port, a second protection ring add port, and a second protection ring drop port, the protection switch comprising:
a first protection ring wavelength selective switch (WSS) coupled to the first working fiber and the first protection fiber, the first protection ring WSS being configured to selectively direct any wavelength channel into the first protection ring drop port, and to selectively direct a first protection ring wavelength channel into the second two-fiber optical channel protection ring or the second protection ring drop port;
a second protection ring WSS coupled to the second working fiber and the second protection fiber, the second protection ring WSS being configured to selectively direct any wavelength channel into the second protection ring drop port, and to selectively direct a second protection ring wavelength channel into the first two-fiber optical channel protection ring or the first protection ring drop port; and
a wavelength selective cross-connect (WSCC) system coupled to the first protection ring WSS and the second protection ring WSS, the WSCC system including at least one WSS, the WSCC being configured to cross-connect any first protection ring wavelength channel into the second protection ring and cross-connect any second protection ring wavelength channel into the first protection ring.

52. The protection switch of claim 51, Further comprising:
a first 2×2 WSS having an input coupled to the first working fiber, an output coupled to the first protection ring WSS, and an output coupled to the first working fiber, the first 1×2 WSS being configured to selectively direct at least one wavelength channel to the first protection ring WSS and to selectively direct at least one express wavelength channel into the first working fiber; and
a second 2×2 WSS having an input coupled to the first protection fiber, an output coupled to the first protection ring WSS, and an output coupled to the first protection fiber, the first 1×2 WSS being configured to selectively direct at least one wavelength channel to the first protection ring WSS and to selectively direct at least one express wavelength channel into the first protection fiber.
a third 2×2 WSS having an input coupled to the first working fiber, an output coupled to the first protection ring WSS, and an output coupled to the first working fiber, the first 1×2 WSS being configured to selectively direct at least one wavelength channel to the first protection ring WSS and to selectively direct at least one express wavelength channel into the first working fiber; and
a fourth 2×2 WSS having an input coupled to the first protection fiber, an output coupled to the first protection ring WSS, and an output coupled to the first protection fiber, the first 1×2 WSS being configured to selectively direct at least one wavelength channel to the first protection ring WSS and to selectively direct at least one express wavelength channel into the first protection fiber.

53. A method for protection switching traffic between a plurality of nodes in a two-fiber optical channel protection ring, the two-fiber optical channel protection ring including a working fiber and a protection fiber, each node including at least one client add port and at least one client drop port, the method comprising:
providing a protection switch in each node of the plurality of nodes, each protection switch including a wavelength selective switch (WSS) configured to selectively drop at least one dropped wavelength channel propagating in the two-fiber optical channel protection ring, and a dynamic spectral equalizer (DSE) configured to substantially block wavelengths corresponding to the at least one wavelength channel, and to optically manage wavelength channels not corresponding to the at least one wavelength channel;
detecting at least one fault condition in the two-fiber optical channel protection ring; and
actuating the protection switch in response to the step of detecting, whereby the traffic is routed to avoid the at least one fault condition.

54. The method of claim 53, wherein the at least one fault condition includes a cable cut between two nodes in the two-fiber optical channel protection ring, whereby working traffic between the two nodes is interrupted.

55. The method of claim 54, wherein at least one protection switch in a node is reconfigured to re-route working traffic using at least one protection wavelength channel.

56. The method of claim 53, wherein the at least one fault condition includes a protection switch failure at one of the nodes in the two-fiber optical channel protection ring, whereby working traffic passing through the node is interrupted.

57. The method of claim 54, wherein at least one protection switch in a node is reconfigured to re-route working traffic using at least one protection wavelength channel.
